(19) United States
(12) Patent Application Publication
(10) Pub. No.: US 2013/0154214 A1
(43) Pub. Date: Jun. 20, 2013

(54) APPLIANCE DOLLY

(71) Applicants: Paul Ryan, Wichita, KS (US); Robert A. Wood, Lincoln, NE (US)

(72) Inventors: Paul Ryan, Wichita, KS (US); Robert A. Wood, Lincoln, NE (US)

(73) Assignee: DG Manufacturing, LLC

(21) Appl. No.: 13/326,219

(22) Filed: Dec. 14, 2011

(51) Int. Cl. B62B 1/12

(52) U.S. Cl. 280/47.18

(57) ABSTRACT

A dolly, according to various embodiments, comprises (1) a frame, (2) a nose plate that is attached adjacent a lower end of the frame; and (3) at least one wheel that is adapted to facilitate the rolling movement of the dolly relative to a support surface. In particular embodiments, the frame comprises: (1) a first side frame assembly; (2) a second side frame assembly that is spaced apart from, and co-facing the first frame assembly; and (3) at least one central connector that extends between the first side frame assembly and the second side frame assembly. The frame may be adapted to be selectively moved from a first orientation to a second, extended orientation in which a length of the frame is greater than a length of the frame in the first orientation.

### CROSS REFERENCE TO RELATED APPLICATIONS

This application claims the benefit of U.S. Design patent application Ser. No. 29/381,270 entitled “Dolly”, which was filed Dec. 16, 2010, and which is hereby incorporated herein by reference.

### BACKGROUND

Dollies are frequently used to move heavy items such as heavy boxes, furniture, and appliances. Currently, in order to move such items with a dolly, a user typically: (1) positions the dolly in front of the item in an upright position with the dolly's nose plate facing the item to be carried; (2) slides the nose plate beneath the item to be carried; (3) pivots the dolly directly backwards so that it rotates about the axis of its wheels and so that the item being carried is lifted off the ground; and (5) proceeds to move the item by pushing the dolly to the desired location on its wheels. At times, due to the large size of the item being moved, this process can be awkward, time-consuming, and physically difficult.

### SUMMARY

A dolly, comprising: (1) a frame assembly, (2) a nose plate that is attached adjacent a lower end of the frame assembly, and (3) a wheel assembly that is attached adjacent a lower end of the frame assembly and adapted to facilitate the rolling movement of the dolly over a support surface that supports the dolly. In particular embodiments, the frame assembly comprises: (1) a first side frame assembly, (2) a second side frame assembly that is spaced apart from and co-facing the first side frame assembly, and (3) at least one central connector that extends between the first side frame assembly and the second side frame assembly. In various embodiments, the dolly is adapted to allow a user to move an object relative to the support surface and the frame is adapted to be selectively moved from a first orientation to a second, extended orientation in which a length of the frame assembly is greater than a length of the frame assembly in the second orientation.

### BRIEF DESCRIPTION OF THE DRAWINGS

Having thus described various embodiments of the invention in general terms, reference will be now be made to the accompanying drawings, which are not necessarily drawn to scale, and wherein:

FIG. 1 is a front perspective view of a dolly with an extendable frame according to a first particular embodiment of the invention in which the dolly's frame is in an unextended orientation.

FIGS. 2-3 are front perspective, close-up views of an upper portion of the dolly of FIG. 1.

FIG. 4 is a front perspective view of the upper portion of the dolly of FIG. 1 in which the frame is in an extended, unlocked orientation.

FIG. 5 is a front perspective view of the upper portion of the dolly of FIG. 1 in which the frame is in an extended, locked orientation.

FIG. 6 is a front perspective view of the dolly of FIG. 1 in which the frame is in an extended, locked orientation.

### DETAILED DESCRIPTION OF VARIOUS EMBODIMENTS

Various embodiments of the disclosed subject matter will now be described more fully hereinafter with reference to the accompanying drawings, in which various embodiments of the disclosed subject matter are shown. This technology may, however, be embodied in many different forms and should not be construed as limited to the embodiments set forth herein. Rather, these embodiments are provided so that this disclosure will be thorough and complete, and will fully convey the scope of the technology to those skilled in the art. Like numbers refer to like elements throughout.

Dolly with Extendable Frame

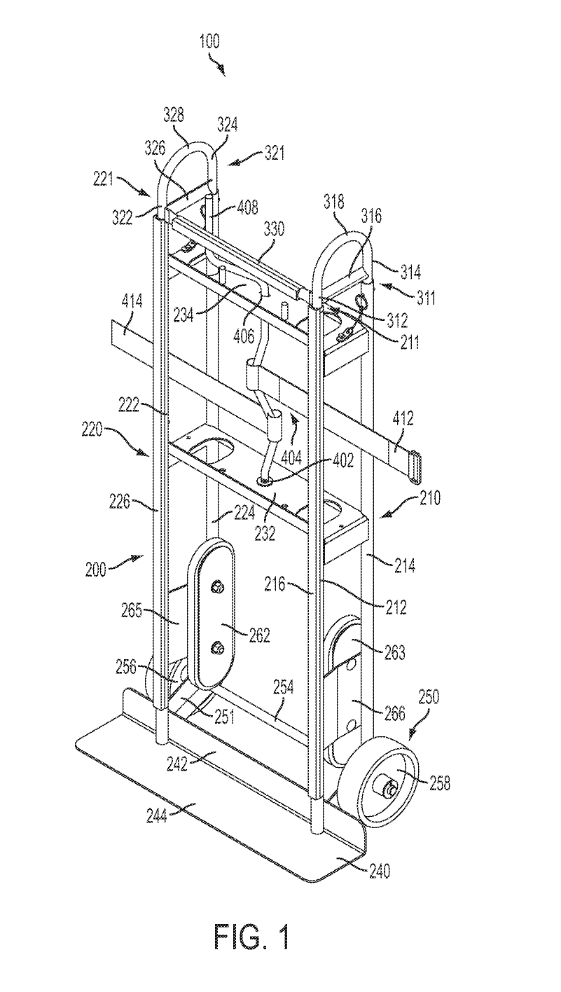

A dolly 100 according to a particular embodiment of the disclosed subject matter is shown in FIG. 1. In this embodiment, the dolly 100 comprises: (1) a frame 200; (2) a nose plate 240 that is attached adjacent (e.g., to) a lower end of the frame; and (3) a wheel assembly 250 that is attached adjacent (e.g., to) a lower end of the frame 200. These various components are discussed in greater detail below.

1. Frame

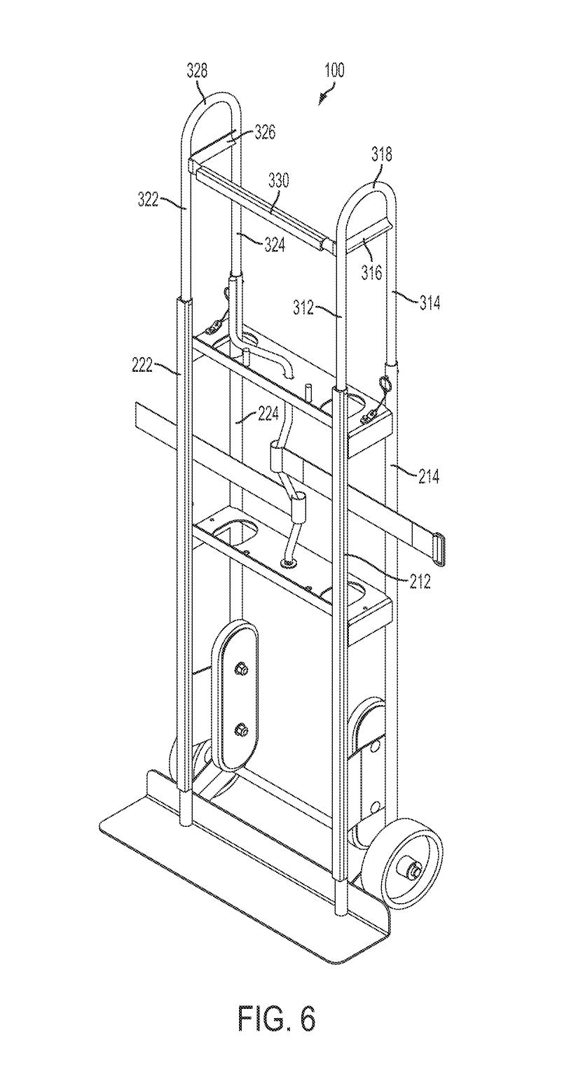

In particular embodiments, the frame 200 is adapted to be selectively moved between: (1) a first orientation, such as the orientation shown in FIG. 1; and (2) a second, extended orientation, such as the orientation shown in FIG. 6 in which the length of the frame 200 is greater than the length of the frame 200 in the first orientation. As shown in FIG. 1, the frame 200 may comprise: (1) a first side frame assembly 210; (2) a second side frame assembly 220 that is spaced apart from, and co-facing the first side frame assembly 210; (3) at least one central connector 232 that extends between the first and second side frame assemblies; and (4) a locking mechanism. These various components are discussed in greater detail below.

2. First Side Frame Assembly

As shown in FIG. 1, the first side frame assembly 210 is substantially planar, positioned at least substantially perpendicular to (e.g., perpendicular to) the front face of the frame 200, and may comprise: (1) a first elongated, telescoping support 211 that is in a substantially vertical orientation when the dolly 100 is in an upright position; and (2) a second elongated, telescoping support 311 that is in at least a substantially vertical orientation when the dolly 100 is in an upright position. The first telescoping support 211 and the second telescoping support 311 are positioned at least substantially parallel to one another.

The first side frame assembly 210 may further comprise a first U-shaped connector 318 that extends between the respective upper ends of the first 211 and second 311 telescoping supports as shown in FIG. 1. The first U-shaped connector 318 is positioned perpendicular to the front face of the frame 200. Additionally, the first U-shaped connector 318 defines an opening in the frame 200 that is suitable for the placement of a user's hand such that the first U-shaped connector 318 may serve as a handle for users operating the dolly 100.

The first side frame assembly 210 is adapted to telescopically extend as the frame 200 is moved from the first orientation shown in FIG. 1 to the second, extended orientation shown in FIG. 6. In various embodiments, the first side frame assembly 210 is also adapted to telescopically retract as the frame 200 is moved from the second, extended orientation shown in FIG. 6 to the first orientation shown in FIG. 1. In this embodiment, the telescopic extension and retraction are achieved through the design of the first 211 and second 311 telescoping supports.

In the embodiment shown in FIG. 1, the first telescoping support 211 is comprised of at least two at least substantially tubular members. In this embodiment, the first telescoping support 211 comprises a first tubular member 212 and a second tubular member 312. The first 212 and second 312 tubular members in this embodiment are hollow and have corresponding cross-sectional tubular shapes. In other embodiments, the first 212 and second 312 tubular members may be non-hollow (e.g., solid). In the embodiment shown in FIG. 1, the first 212 and second 312 tubular members have a substantially circular cross section. In other embodiments, these tubular members may have other suitable cross sectional shapes (e.g., substantially square or rectangular shapes). In various embodiments, the dimensions of the inner surface of the first tubular member 212 at least generally corresponds to the dimensions of the outer surface of the second tubular member 312 such that the second tubular member 312 can nest within the first tubular member 212 with sufficient clearance to facilitate smooth telescoping and sufficient snugness to provide rigidity of the first telescoping support 211 in the second, extended orientation.

Similarly, the second telescoping support comprises a third tubular member 214 and a fourth tubular member 314. The third 214 and fourth 314 tubular members are hollow and have corresponding cross sectional tubular shapes. The dimensions of the inner surface of the third tubular member 214 correspond to the dimensions of the outer surface of the fourth tubular member 314 such that the fourth tubular member 314 can nest within the third tubular member 214 with sufficient clearance to facilitate both smooth telescoping and sufficient snugness to provide rigidity of the third telescoping support 311 in the second, extended orientation.

The first side frame assembly 210 further comprises a first connecting member 316 that extends between the upper portion of the second tubular member 312 and the fourth tubular member 314. The first connecting member 316 is at least substantially perpendicular to (e.g., perpendicular to) the second 312 and fourth 314 tubular members and runs parallel to the support surface when the frame 200 is in an upright position. The first connecting member 316 may be made of any suitable material and may be affixed to the second 312 and fourth 314 tubular members by any suitable means.

In the embodiment shown in FIG. 1, the first side frame assembly 210 includes a first rail guard 216. The first rail guard 216 is an elongated member with a substantially flat front side. In this embodiment, the first rail guard 216 extends along the front edge of the first side frame assembly 210 from the top of the nose plate 240 to the top of the first tubular member 212. The first rail guard 216 may be affixed to the first side frame assembly 210 using any suitable means. In this embodiment, the first rail guard may provide a flat surface on which items transported using the dolly 100 may rest.

3. Second Side Frame Assembly

As shown in FIG. 1, the second side frame assembly 220 is structurally similar to (e.g., structurally identical to), spaced apart from, and co-facing the first side frame assembly 210. The second side frame assembly 220 is substantially planar and may comprise: (1) a third elongated, telescoping support 221 that is in a substantially vertical (e.g., vertical) orientation when the dolly is in an upright position; and (2) a fourth elongated, telescoping support 321 that is in at least a substantially vertical (e.g., vertical) orientation when the dolly is in an upright position. The third telescoping support 221 and the fourth telescoping support 321 are positioned at least substantially parallel to (e.g., parallel to) one another.

The second side frame assembly 220 may further comprise a second U-shaped connector 328 that extends between the respective upper ends of the third 221 and fourth 321 telescoping supports as shown in FIG. 1. The second U-shaped connector 328 is positioned at least substantially perpendicular to the front face of the frame 200 and at least substantially parallel to the first side frame assembly 210. Additionally, the second U-shaped connector 328 defines an opening in the frame 200 that is suitable for the placement of a user's hand such that the second U-shaped connector 328 may serve as a handle for users operating the dolly 100.

The second side frame assembly 220 is adapted to telescopically extend as the frame 200 is moved from the first orientation shown in FIG. 1 to the second, extended orientation shown in FIG. 6. In various embodiments, the second side frame assembly 220 is also adapted to telescopically retract as the frame 200 is moved from the second, extended orientation shown in FIG. 6 to the first orientation shown in FIG. 1. In this embodiment, the telescopic extension and retraction are achieved through the design of the third 221 and fourth 321 telescoping supports.

In the embodiment shown in FIG. 1, the third telescoping support 221 is comprised of at least two at least substantially tubular members. In this embodiment, the third telescoping support comprises a fifth tubular member 222 and a sixth tubular member 322. The fifth 222 and sixth 322 tubular members in this embodiment are hollow and have corresponding cross sectional tubular shapes. Other embodiments include fifth 222 and sixth 322 tubular members that are non-hollow (e.g., solid). In the embodiment shown in FIG. 1, the fifth 222 and sixth 322 tubular members have at least a substantially circular cross section. In other embodiments, the tubular members may have other suitable cross sectional shapes (e.g., substantially square or rectangular shapes). In various embodiments, the dimensions of the inner surface of the fifth tubular member 222 correspond to the dimensions of the outer surface of the sixth tubular member 322 such that the sixth tubular member 322 can nest within the fifth tubular member 222 with sufficient clearance to facilitate smooth telescoping and sufficient snugness to provide rigidity of the third telescoping support 221 in the second, extended orientation.

Similarly, the fourth telescoping support 321 comprises a seventh tubular member 224 and an eighth tubular member 324. The seventh 224 and eighth 324 tubular members are hollow and have corresponding cross sectional tubular shapes. The dimensions of the inner surface of the seventh tubular member 224 correspond to the dimensions of the outer surface of the eighth tubular member 324 such that the eighth tubular member 324 can nest within the seventh tubular member 224 with sufficient clearance to facilitate both smooth telescoping and sufficient snugness to provide rigidity of the fourth telescoping support 321 in the second, extended orientation.

The second side frame assembly 220 further comprises a second connecting member 326 that extends between the upper portion of the sixth tubular member 322 and the eighth tubular member 324. The second connecting member 326 is at least substantially perpendicular (e.g., perpendicular to) the sixth 322 and seventh 324 tubular members and runs parallel to the support surface supporting the dolly 100 when the frame 200 is in an upright position. The second connecting member 326 may be made of any suitable material and may be affixed to the sixth 322 and eighth 324 tubular members by any suitable means.

In the embodiment shown in FIG. 1, the second side frame assembly 220 includes a second rail guard 226. The second rail guard 226 is an elongated member with a substantially flat front side. In this embodiment, the second rail guard 226 extends along the front edge of the second side frame assembly 220 from the top of the nose plate 240 to the top of the fifth tubular member 222. The second rail guard 226 may be affixed to the second side frame assembly 220 using any suitable means. In this embodiment, the second rail guard may provide a flat surface on which items transported using the dolly 100 may rest.

4. Central Connector

As shown in FIG. 1, the frame 200 may include at least one central connector 232. In this embodiment, a first central connector 232 extends between the first 210 and second 220 side frame assemblies and may be attached adjacent (e.g., to) the first and second side frame assemblies 210, 220 in any suitable manner (e.g., using suitable fasteners or welding techniques). The first central connector 232 also extends between the first 212 and third 214 tubular members of the first side frame assembly 210 as well as between the fifth 222 and seventh 224 tubular members of the second side frame assembly 220.

On the first side frame assembly 210, the first central connector 232 is attached adjacent (e.g., to) the first 212 and third 214 tubular members. On the second side frame assembly 220, the first central connector 232 is attached adjacent (e.g., to) to the fifth 222 and seventh 224 tubular members.

In various embodiments, the first central connector 232 extends at least substantially perpendicular to (e.g., perpendicular to) the first 210 and second 220 side frame assemblies. In various embodiments, when the dolly 100 is in an upright position, the first central connector 232 is oriented at least substantially parallel to (e.g., parallel to) a support surface supporting the dolly 100. In various embodiments, the first central connector 232 may be made of any suitable material (e.g., a suitable metal such as aluminum, or plastic) capable of rigidly attaching: (1) the first side frame assembly 210 to the second side frame assembly 220; (2) the first tubular member 212 to the third tubular member 214; and (3) the fifth tubular member 222 to the seventh tubular member 224.

In the embodiment shown in FIG. 1, the dolly 100 includes a second central connector 234 that is substantially similar to (e.g., substantially identical to) the first central connector 232. In this embodiment, the second central connector 234 extends between an upper portion of the first 210 and second 220 side frame assemblies when the frame 200 is in a substantially vertical position.

In the embodiment shown in FIG. 1, an upper central connector 330 extends between the first 210 and second 220 side frame assemblies and may be attached in any suitable manner (e.g., using suitable fasteners or welding techniques). In this embodiment, the upper central connector 330 is an elongated rod. The first end of the upper central connector 330 is attached adjacent both the first U-shaped connector 318 and the upper end of the first side frame assembly 210. In this embodiment, the first end of the upper central connector 330 is attached adjacent (e.g., to) the second tubular member 312 and is both at least substantially perpendicular to and adjacent to the first connecting member 316.

The second end of the upper central connector 330 is attached adjacent both the second U-shaped connector 328 and the upper end of the second side frame assembly 220. In this embodiment, the second end of the upper central connector 330 is attached adjacent (e.g., to) the sixth 322 tubular member and is both at least substantially perpendicular and adjacent to the second connecting member 326. The upper central connector 330 is positioned at least substantially perpendicular to the first 210 and second 220 side frame assemblies and parallel to the support surface supporting the dolly 100 when the dolly 100 is an upright position. The upper central connector 330 in this embodiment is positioned along the front face of the frame 200. In particular embodiments, as the frame 200 is moved from the first orientation shown in FIG. 1 to the second, extended orientation shown in FIG. 6, the upper central connector 330 moves away from the first central connector 232.

5. Locking Mechanism

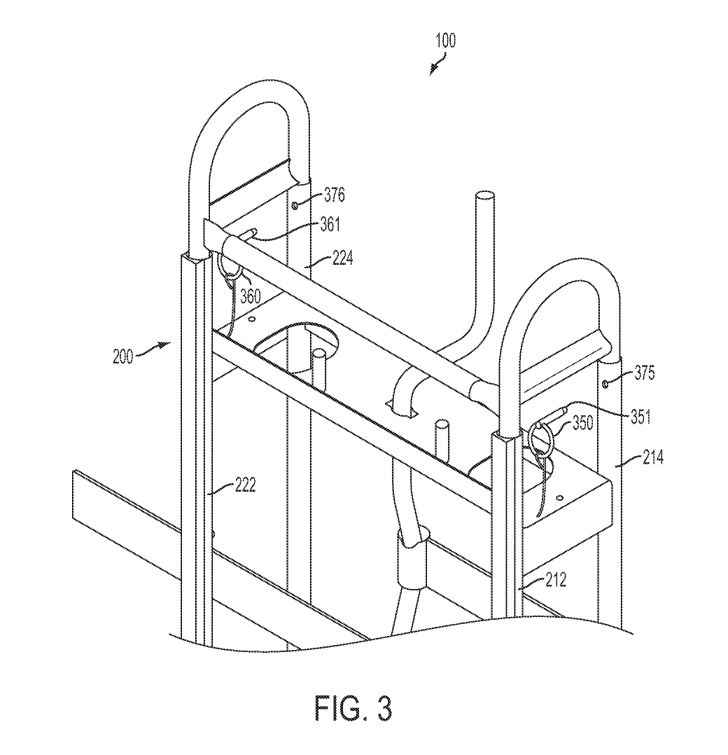

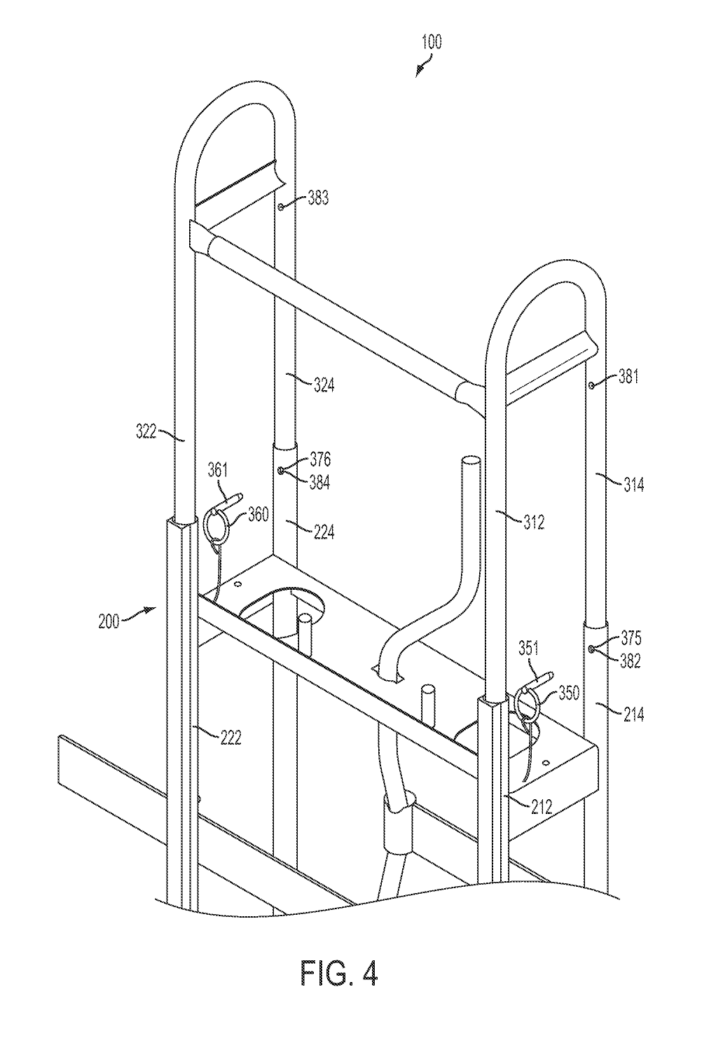

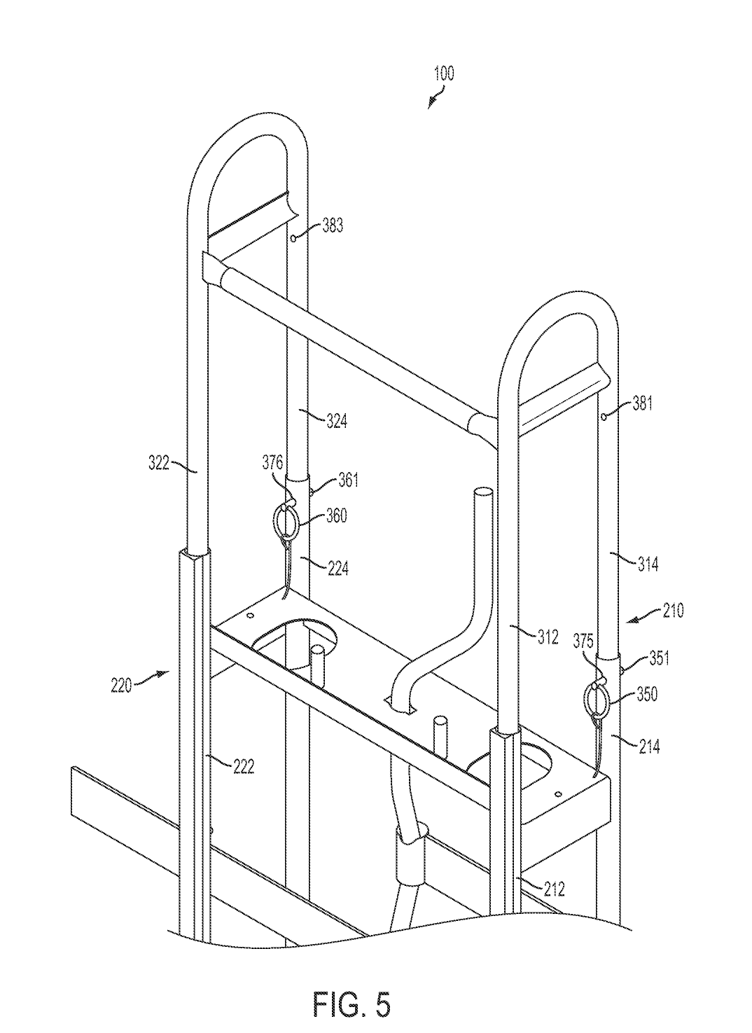

As shown in FIGS. 3-5, the frame 200 may include a locking mechanism that is adapted for selectively: (1) locking the frame 200 in the first orientation shown in FIG. 1; and (2) locking the frame 200 in the second, extended orientation shown in FIG. 6. In the embodiment of FIGS. 4 and 5, the locking mechanism comprises a first locking mechanism 350 adapted for locking the first side frame assembly 210 in either the first orientation shown in FIG. 1 or the second, extended orientation shown in FIG. 6. In the embodiment of FIGS. 4 and 5, the first locking mechanism 350 includes a pin 351 received within a first opening 375 in the third tubular member 314, and selectively received within a second opening 381 or third opening 382 in the fourth tubular member 314. The locking mechanism in the current embodiment further comprises a second locking mechanism 360 (e.g., a pin 361) that is adapted for locking the second side frame assembly 220 in either the first orientation shown in FIG. 1 or the second, extended orientation shown in FIG. 6. In the embodiment of FIGS. 4 and 5, the second locking mechanism 360 includes a pin 361 received within a fourth opening 376 in the seventh tubular member 224, and selectively received within a fifth opening 383 or sixth opening 384 in the eighth tubular member 324. Although each of the fourth tubular member 314 and eighth tubular member 324 are shown with only two openings, the tubular members 314, 324 may include a plurality of holes for operating in conjunction with the locking mechanisms 350, 360.

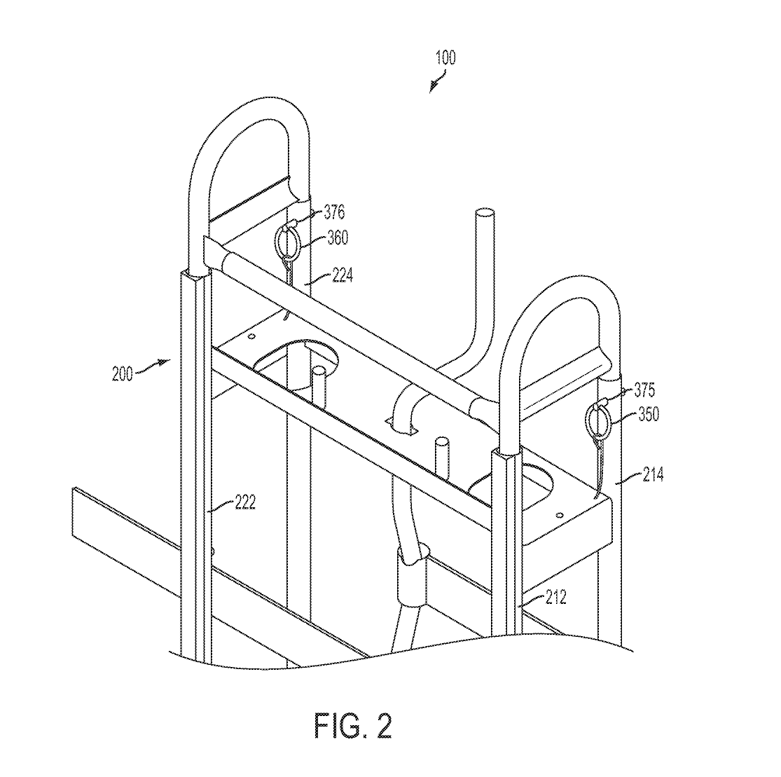

FIGS. 2-5 show the transition from: (1) an unextended, locked orientation in which the first locking mechanism 350 is engaged within the first opening 375 and second opening 381, and the second locking mechanism 360 is engaged within the fourth opening 376 and fifth opening 383 (see FIG. 2); to (2) an unextended, unlocked orientation in which the first 350 and second 360 locking mechanisms are disengaged (see FIG. 3); to (3) an extended, unlocked orientation in which the first 350 and second 360 locking mechanisms are disengaged (see FIG. 4); to (4) an extended, locked orientation in which the first locking mechanism 350 is engaged within the first opening 375 and third opening 382, and the second locking mechanism 360 is engaged within the fourth opening 376 and sixth opening 384 (see FIG. 5).

In the embodiment shown in FIG. 1, the dolly's extending frame 200 may be locked in a particular orientation by inserting the pin 351 of the first locking mechanism 350 through the corresponding holes through both the third tubular member 214 and the fourth tubular member 314 and inserting the pin 361 of the second locking mechanism 360 through the corresponding holes through both the seventh tubular member 224 and the eighth tubular member 324. Other embodiments of the dolly 100 include other suitable locking mechanisms such as a push-button release or a locking collar.

6. Strapping System

In the embodiment shown in FIG. 1, the frame 200 includes a strapping system 404 that is disposed adjacent the frame 200. The strapping system 404 comprises a mechanism for strapping items to the dolly's frame 200 using a strap 412, 414. The strapping system 404 further comprises a mechanism 408 that rotates within a first opening 402 defined on the first central connector 232 and a second opening 406 defined on the second central connector 234 for selectively tightening and locking the strap 412, 414.

7. Skid Plates

As shown in FIG. 1, the frame 200 may further comprise one or more skid plates 262, 263. The skid plates 262, 263 may be attached in any suitable manner to rigidly secure the skid plates 262, 263 to skid plate mounts 265, 266, which are disposed within the interior of the lower portion of the frame 200. In various embodiments, the skid plates 262, 263 are manufactured from a resilient material and protrude beyond the rear end of the frame 200 when the frame 200 is in a substantially vertical position in order to provide a flat, solid surface on which the dolly 100 can slide while being pulled up and down the edge of a surface including stairs. Alternatively, the skid plates may comprise an assembly including belts that rotate about wheels where the belt contacts the edge of a surface and rotates around the wheels as the dolly 100 is pulled up and down the edge of a surface.

8. Nose Plate

The dolly 100 may include any suitable type of nose plate 240. As shown in FIG. 1, the nose plate 240 may include: (1) a substantially planar support plate 244: and (2) a substantially planar face plate 242 that extends upwardly adjacent a rear edge of the support plate 242. The nose plate 240 is adapted to support a load and may be attached adjacent a lower end of the dolly 100 frame 200 in any suitable manner (e.g., using suitable fasteners or welding techniques).

9. Wheel Assembly

In particular embodiments, the dolly's wheel assembly is attached adjacent a lower end of the frame assembly 200 and comprises at least one wheel 256, 258 that is adapted to facilitate the rolling movement of the dolly 100 over a support surface supporting the dolly 100. In the embodiment shown in FIG. 1, the wheel assembly includes: (1) a first axle support (not shown); (2) a second axle support 251; and (3) an axle 254. The first axle support (not shown) provides a suitable means for supporting the first end of the axle 254 near the bottom edge of the frame 200 at the base of the first side frame assembly 210. The second axle support 251 provides a suitable means for supporting the second end of the axle 254 near the bottom edge of the frame 200 at the base of the second side frame assembly 220. The axle 254 extends through the first (not shown) and second 251 axle supports so that the axle 254 is substantially parallel to the support surface that supports the dolly 100 when the dolly 100 is in an upright orientation. The wheel assembly may further include a pair of wheels 256, 258 that are rotatably mounted, respectively, to opposite ends of the dolly's axle 254.

Dolly Operating Position Conversion

In the embodiment shown in FIGS. 1-6 the frame 200 is adapted for selective conversion between: (1) a first orientation as shown in FIG. 1; and (2) a second, extended orientation shown in FIG. 6 in which the length of the frame 200 in the second orientation is greater than the length of the frame 200 in the first orientation. In the first orientation, the dolly 100 is useful for moving small to medium sized objects (e.g., a dorm room refrigerator). In the second, extended orientation, the dolly is useful for moving large objects such as appliances (e.g., a full sized refrigerator). To convert the frame 200 from the first orientation to the second orientation, the user may disengage the first 350 and second 360 locking mechanisms. The user may then move the frame into the second, extended orientation. Finally, the user may reengage the first 350 and second 360 locking mechanisms to lock the dolly 100 in the extended position.

### Alternative Embodiments

Alternative embodiments of the dolly 100 may comprise components that are, in some respects, similar to the various components described above. Particular features of these alternative embodiments are discussed below.

1. Plurality of Central Connectors

In particular embodiments, the frame 200 may contain a plurality of central connectors in addition to the first 232, second 234, and upper 330 central connectors. Additional central connectors may be positioned at various positions adjacent the frame 200. The additional central connectors may be substantially similar to (e.g., substantially identical to) the first central connector 232 or may take any form that provides additional rigidity to the dolly frame 200.

2. Extendable Dolly with Non-Parallel Side Frame Assemblies

In particular embodiments, the first 210 and second 220 side frame assemblies may be non-parallel. For example, the first frame assembly 210 may be positioned such that the first frame assembly 210 and a line that is perpendicular to the front face of the frame 200 form an acute angle. Similarly, the second frame assembly 220 may be positioned such that the second frame assembly 220 and a line perpendicular to the front face of the frame 200 form an acute angle. The resulting frame 200 in such an embodiment may be, for example, wider along its front face than its rear face when the dolly 100 is in an upright orientation. This embodiment may provide a larger surface area on the front of the frame 200 allowing for easier transportation of larger objects using the dolly 100.

3. Extendable Dolly that Folds and Unfolds

In various embodiments, the extending functionality of the dolly 100 is achieved with a frame 200 that is adapted to selectively fold and unfold in order to increase the length of the frame 200.

### CONCLUSION

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. Therefore, it is to be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

1-8. (canceled)

9. A dolly, comprising:
(A) a frame assembly, comprising:
a first side frame assembly that comprises a first elongated, telescoping support that is in a substantially vertical orientation when the dolly is in an upright position, and a second elongated, telescoping support that is in at least a substantially vertical orientation when the dolly is in an upright position;
a second side frame assembly spaced apart from, and co-facing, the first side frame assembly, the second side frame comprising a third elongated, telescoping support that is in a substantially vertical orientation when the dolly is in an upright position, and a fourth elongated, telescoping support that is in a substantially vertical orientation when the dolly is in an upright position; and
at least one central connector that extends between the first side frame assembly and the second side frame assembly;
(B) a nose plate that is attached adjacent a lower end of the frame assembly; and
(C) a wheel assembly that is attached adjacent a lower end of the frame assembly, the wheel assembly comprising at least one wheel that is adapted to facilitate the rolling movement of the dolly over a support surface supporting the dolly, wherein:
(A) the dolly is adapted to allow a user to move an object relative to the support surface by:
(1) placing the object on the nose plate of the dolly; and
(2) while the object is disposed on the nose plate, rolling the dolly, on the at least one wheel, over the support surface;
(B) the frame is adapted to be selectively moved from:
(1) a first orientation, to
(2) a second, extended orientation in which a length of the frame is greater than a length of the frame in the first orientation;
(C) the first and second telescoping supports are each adapted for:
(1) telescoping into an extended orientation as the frame assembly is moved from the first orientation to the second, extended orientation; and
(2) retracting as the frame is moved from the second, extended orientation into the first orientation; and
(D) the third and fourth telescoping supports are each adapted for telescoping into an extended orientation as the frame assembly is moved from the first orientation to the second, extended orientation.

10. The dolly of claim 9, wherein the third and fourth telescoping supports are each adapted for telescopically retracting as the frame assembly is moved from the second, extended orientation into the first orientation.

11. A dolly, comprising:
(A) a frame assembly, comprising:
a first side frame assembly;
a second side frame assembly spaced apart from, and co-facing, the first side frame assembly;
at least one central connector that extends between the first side frame assembly and the second side frame assembly; and
an upper central connector that extends between the first and second side frame assemblies;
(B) a nose plate that is attached adjacent a lower end of the frame assembly; and
(C) a wheel assembly that is attached adjacent a lower end of the frame assembly, the wheel assembly comprising at least one wheel that is adapted to facilitate the rolling movement of the dolly over a support surface supporting the dolly, wherein:
(A) the dolly is adapted to allow a user to move an object relative to the support surface by:
(1) placing the object on the nose plate of the dolly; and
(2) while the object is disposed on the nose plate, rolling the dolly, on the at least one wheel, over the support surface;
(B) the frame is adapted to be selectively moved from:
(1) a first orientation, to
(2) a second, extended orientation in which a length of the frame is greater than a length of the frame in the first orientation; and
(C) the upper central connector moves away from the first central connector as the frame assembly is moved from the first orientation into the second, extended orientation.

12. A dolly, comprising:
(A) a frame assembly, comprising:
a first side frame assembly that comprises a first elongated, telescoping support that is in a substantially vertical orientation when the dolly is in an upright position, a second elongated, telescoping support that is in at least a substantially vertical orientation when the dolly is in an upright position, and a substantially U-shaped connector that extends between the respective upper ends of the first and second telescoping supports;
a second side frame assembly spaced apart from, and co-facing, the first side frame assembly;
at least one central connector that extends between the first side frame assembly and the second side frame assembly; and
(B) a nose plate that is attached adjacent a lower end of the frame assembly; and
(C) a wheel assembly that is attached adjacent a lower end of the frame assembly, the wheel assembly comprising at least one wheel that is adapted to facilitate the rolling movement of the dolly over a support surface supporting the dolly, wherein:
(A) the dolly is adapted to allow a user to move an object relative to the support surface by:
(1) placing the object on the nose plate of the dolly; and
(2) while the object is disposed on the nose plate, rolling the dolly, on the at least one wheel, over the support surface;
(B) the frame is adapted to be selectively moved from:
(1) a first orientation, to
(2) a second, extended orientation in which a length of the frame is greater than a length of the frame in the first orientation;
(C) the first and second telescoping supports are each adapted for:
(1) telescoping into an extended orientation as the frame assembly is moved from the first orientation to the second, extended orientation; and
(2) retracting as the frame is moved from the second, extended orientation into the first orientation.

13. The dolly of claim 12, wherein:
the U-shaped connector is a first U-shaped connector; and
the second side frame further includes a second substantially U-shaped connector that extends between the respective upper ends of the third and fourth telescoping supports.

14. The dolly of claim 13, wherein:
the first end of the upper central connector is attached adjacent the first U-shaped connector; and
the second end of the upper central connector is attached adjacent the second U-shaped connector.

15-20. (canceled)

21. A dolly, comprising:
a frame assembly, comprising:
a first side frame assembly comprising:
a first elongated, telescoping support; and
a second elongated, telescoping support;
a second side frame assembly that is spaced apart from, and adjacent the first side frame assembly, said second side frame assembly comprising:
a third elongated, telescoping support; and
a fourth elongated, telescoping support;
at least one central connector that extends between the first side frame assembly and the second side frame assembly, wherein:
the frame assembly is adapted for movement between a first orientation and a second orientation in which the length of the frame assembly is greater in the second orientation than the length of the frame assembly in the first orientation;
the first telescoping support and the second telescoping support are each adapted for extending as the frame assembly is moved into the second orientation; and
the third telescoping support and the fourth telescoping support are each adapted for extending as the frame assembly is moved into the second orientation.
a nose plate attached adjacent a lower end of the frame assembly; and
a wheel assembly attached adjacent a lower end of the frame assembly, the wheel assembly comprising at least a wheel for rolling the dolly over a surface supporting the dolly.

22. The dolly of claim 21, wherein the first side frame assembly further comprises a first substantially U-shaped connector that extends between the third elongated, telescoping support and the fourth elongated, telescoping support.

23. The dolly of claim 21, further comprising a central connector extending between and attached to the first elongated, telescoping support and the third elongated, telescoping support.

24-25. (canceled)

26. A dolly, comprising:
a frame assembly, comprising:
a first side frame assembly comprising:
a second tubular member slideably received within a first tubular member;
a fourth tubular member slideably received within a third tubular member; and
a first substantially U-shaped connector extending between the second tubular member and the fourth tubular member;
a second side frame assembly that is spaced apart from, and adjacent the first side frame assembly, the second side frame assembly comprising:
a sixth tubular member slideably received within a fifth tubular member;
an eighth tubular member slideably received within a seventh tubular member; and
a second substantially U-shaped connector extending between the sixth tubular member and the eighth tubular member;
at least one central connector that extends between the first side frame assembly and the second side frame assembly, wherein the central connector is a first central connector; and
a second central connector having a first end and a second end, wherein the first end of the second central connector is attached adjacent the first U-shaped connector, and the second end of the second central connector is attached adjacent the second U-shaped connector;
wherein the frame assembly is adapted for movement between a first orientation and a second orientation in which the length of the frame assembly is greater in the second orientation than the length of the frame assembly in the first orientation;
a nose plate attached adjacent a lower end of the frame assembly; and
a wheel assembly attached adjacent a lower end of the frame assembly, the wheel assembly comprising at least a wheel for rolling the dolly over a surface supporting the dolly.

27. The dolly of claim 26, further comprising:
a first locking mechanisms for selectively locking the first side frame assembly;
a second locking mechanism for selectively locking the second side frame assembly; and
wherein the first and second locking mechanism lock the frame assembly in the first orientation and the second orientation.

28. A dolly, comprising:
a frame assembly, comprising:
a first side frame assembly comprising:
a first elongated support comprising a first member and a second member; and
a second elongated support comprising a third member and a fourth member;
a second side frame assembly that is spaced apart from, and adjacent the first side frame assembly;
at least one central connector that extends between the first side frame assembly and the second side frame assembly, wherein;
the frame assembly is adapted for movement between a first orientation and a second orientation in which the length of the frame assembly is greater in the second orientation than the length of the frame assembly in the first orientation;
the first member and the second member are adapted to slide relative to one another as the frame assembly is moved from the first orientation into the second orientation; and
the third member and the fourth member are adapted to slide relative to one another as the frame assembly is moved from the first orientation into the second orientation;
a nose plate attached adjacent a lower end of the frame assembly; and
a wheel assembly attached adjacent a lower end of the frame assembly, the wheel assembly comprising at least a wheel for rolling the dolly over a surface supporting the dolly.

29. The dolly of claim 28, wherein said dolly further comprises:
a first substantially U-shaped connector that extends between the first elongated support and the second elongated support.

30. The dolly of claim 28, wherein the second side frame assembly includes:
a third elongated support comprising a fifth member and a sixth member; and
a fourth elongated support comprising a seventh member and an eight member, wherein:
the fifth support and the sixth support are adapted to slide relative to one another as the frame assembly is moved from the first orientation into the second orientation; and
the seventh support and the eighth support are adapted to slide relative to one another as the frame assembly is moved from the first orientation into the second orientation.
